(19) United States
(12) Patent Application Publication
(10) Pub. No.: US 2026/0122433 A1
(43) Pub. Date: Apr. 30, 2026

(54) EAR-WEARABLE ELECTRONIC DEVICE SYSTEM

(71) Applicant: Starkey Laboratories, Inc., Eden Prairie, MN (US)

(72) Inventors: Jacques André Grange, Cardiff (GB); Dave Fabry, Eden Prairie, MN (US)

(21) Appl. No.: 19/353,847

(22) Filed: Oct. 9, 2025

Related U.S. Application Data
(60) Provisional application No. 63/712,016, filed on Oct. 25, 2024.

(51) Int. Cl. H04R 25/00; G06F 3/0346; G06V 40/16

(52) U.S. Cl. CPC H04R 25/505; G06F 3/0346; G06V 40/171; H04R 25/405; H04R 25/407; H04R 2225/43

(57) ABSTRACT

Various embodiments of an ear-wearable electronic device system are disclosed. The system includes first and second hearing devices each including a microphone configured to convert sensed acoustic waves to an audio signal. The system further includes a controller operatively coupled to the first and second hearing devices and configured to receive first and second audio information based on the audio signals from the microphones, determine a scene analysis based on at least one of the first audio information or the second audio information, determine whether a present head orientation of the wearer relative to speech and one or more noise sources corresponds to an optimal head orientation based on the scene analysis, and initiate a prompt to instruct the wearer to turn the head to the optimal head orientation if the present head orientation does not correspond to the optimal head orientation.

This application claims the benefit of U.S. Provisional Application No. 63/712,016, filed October 25, 2024, the disclosure of which is incorporated by reference herein in its entirety.

### BACKGROUND

When listening and turning an ear towards a sound source that is difficult to discern from a background, we naturally listen through our “better ear” (i.e., the ear that is acoustically favored in that it receives the best signal-to-noise ratio (SNR)) and mostly ignore the signal arriving at the other ear. This instinctive head turn is often exhibited in reverberant and/or noisy environments such as noisy social or work settings because it is very effective at improving access to the target signal. The benefit of a head turn away from directly facing a target exists because of the head-shadow effect, i.e., the ear placed in the hemifield ipsilateral to the target source (i.e., that turned towards the target source) typically receives the highest SNR, making that ear the better ear. Conversely, the ear placed in the hemifield contralateral to a target source typically receives the lowest SNR.

Normal-hearing individuals benefit from the additional information contained in the signal arriving at the poorer ear (the one acoustically penalized). This benefit is called “binaural unmasking” and stems from further rejecting the noise at the central processing level of the auditory brain by comparing information between the ears. Hearing impairment most often affects both peripheral processes (transduction of sound into neural signals in the cochlea) and more central processes (both monaural and binaural processes in the brain stem and cortex). In the hearing impaired (HI), this reduces access to interaural time delays, the perceptual cue that enables binaural unmasking. Binaural unmasking is also much reduced, even with normal hearing, by reverberation and by the spatial distribution of sound sources typically found in social settings (those competing with perception of the target source, e.g., noises or interfering voices in a restaurant). As a result, better-ear listening, the purely acoustic and monaural benefit or a head orientation that maximizes SNR at the better ear, becomes the most effective way to maximize, for instance, the intelligibility of a target talker in a noisy social or work setting. When coupled with the lip-reading the HI are typically highly reliant on for speech intelligibility in noise, Grange and Culling (The Benefit of Head Orientation to Speech Intelligibility in Noise, J. Acoust. Soc. Am. 139, 703–712 (2016)) and Grange et al. (Turn an Ear to Hear: How Hearing-Impaired Listeners Can Exploit Head Orientation to Enhance Their Speech Intelligibility in Noisy Social Settings. Trends in Hearing. 2018;22. doi:10.1177/2331216518802701 (2018)) showed that a modest, 30-degree head turn away from facing the target talker provides the best combination of head-orientation and lipreading benefits.

If the hearing impairment is symmetrical, the best ear to turn towards the target may be either ear, but the specific acoustic properties of the space surrounding the HI listener may make turning the head one way more effective than turning it the other. However, if impairment is sufficiently asymmetrical, turning the better hearing ear towards the target will likely be the most effective listening strategy. The extreme case of unilateral deafness makes which ear to turn towards the talker obvious. As a result, listeners in that category are much more prone to exploiting the acoustic and perceptual benefit of head orientation. This is also reinforced by the fact that unilaterally deaf listeners must use head orientation to scan the environment for any chance of localizing sound sources.

### SUMMARY

In general, the present disclosure provides various embodiments of an ear-wearable electronic device system. The system can include first and second hearing devices each configured to be disposed on or in an ear of the wearer. Each hearing device can also include a microphone that is configured to sense acoustic waves from an environment of the wearer and convert the sensed acoustic waves to an audio signal. A controller of the system can be operatively coupled to the first and second hearing devices and can be configured to determine whether a present head orientation of the wearer relative to speech and one or more noise sources corresponds to an optimal head orientation based on scene analysis also determined by the controller. If the present head orientation does not correspond to the optimal head orientation, then the controller is further configured to initiate a prompt to instruct the wearer to turn the head to the optimal head orientation. The prompt can include any suitable indicator that suggests to the wearer to turn the head to the optimal head position, e.g., at least one of a visual signal, an auditory signal, or a haptic signal. The optimal head position can improve the intelligibility of acoustic information that is directed from the acoustic source to the wearer.

In one aspect, the present disclosure provides an ear-wearable electronic device system that includes a first hearing device configured to be disposed on or in a first ear of a wearer and including a microphone that is configured to sense acoustic waves from an environment of the wearer and convert the sensed acoustic waves to a first audio signal, a second hearing device configured to be disposed on or in a second ear of the wearer and including a microphone that is configured to sense acoustic waves from the environment of the wearer and convert the sensed acoustic waves to a second audio signal, and a controller operatively coupled to the first and second hearing devices and including one or more processors. The controller is configured to receive first audio information based on the first audio signal and second audio information based on the second audio signal, determine a scene analysis based on at least one of the first audio information or the second audio information, and determine whether a present head orientation of the wearer relative to speech and one or more noise sources corresponds to an optimal head orientation based on the scene analysis. The controller is further configured to initiate a prompt to instruct the wearer to turn the head to the optimal head orientation if the present head orientation does not correspond to the optimal head orientation.

In another aspect, the present disclosure provides a method that includes receiving first audio information based on a first audio signal that is converted by a first microphone of a first hearing device from acoustic waves sensed by the first microphone from an environment of a wearer of the first hearing device, receiving second audio information based on a second audio signal that is converted by a second microphone of a second hearing device from acoustic waves sensed by the second microphone from the environment of the wearer, and determining a scene analysis based on at least one of the first audio information or the second audio information. The method further includes determining a present head orientation of a head of the wearer relative to speech and one or more noise sources, determining an optimal head orientation, determining whether the present head orientation corresponds to the optimal head orientation based on the scene analysis and initiating a prompt to instruct the wearer to turn the head to the optimal head orientation if the present head orientation does not correspond to the optimal head orientation.

In another aspect, the present disclosure provides a hearing device system that includes a first hearing device configured to be disposed on or in a first ear of a wearer, where the first hearing device includes a first microphone that is configured to sense acoustic waves from an environment of the wearer and convert the sensed acoustic waves to a first audio signal, and a first receiver configured to provide acoustic energy to the first ear based on a first receiver signal. The system further includes a second hearing device configured to be disposed on or in a second ear of the wearer, where the second hearing device includes a second microphone that is configured to sense acoustic waves from the environment of the wearer and convert the sensed acoustic waves to a second audio signal, and a second receiver configured to provide acoustic energy to the second ear based on a second receiver signal. The system further includes a controller operatively coupled to the first and second hearing devices and including one or more processors. The controller is configured to receive first audio information based on the first audio signal and receive second audio information based on the second audio signal, determine a scene analysis based on at least one of the first audio information or the second audio information, and determine whether a present head orientation of the wearer relative to speech and one or more noise sources corresponds to an optimal head orientation based on the scene analysis. The controller is further configured to initiate a prompt to instruct the wearer to turn the head to the optimal head orientation if the present head orientation does not correspond to the optimal head orientation.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. The term “consisting of” means “including,” and is limited to whatever follows the phrase “consisting of.” Thus, the phrase “consisting of” indicates that the listed elements are required or mandatory and that no other elements may be present. The term “consisting essentially of” means including any elements listed after the phrase and is limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic perspective view of one embodiment of an ear-wearable electronic device system disposed on or proximate to a head of a wearer.

FIG. 2 is a schematic diagram of the ear-wearable electronic device system of FIG. 1.

FIG. 3 is a schematic diagram of one embodiment of a first hearing device of the ear-wearable electronic device system of FIGS. 1-2.

FIG. 4 is a schematic diagram of one embodiment of a second hearing device of the ear-wearable electronic device system of FIGS. 1-2.

FIG. 5 is a schematic diagram of the head of the wearer in relation to an acoustic source and an ambient noise source, where the ear-wearable electronic device system of FIGS. 1-2 is disposed on or proximate to the head.

FIG. 6 is a schematic diagram of the head of the wearer in relation to the acoustic source and the ambient noise source, where the ear-wearable electronic device system of FIGS. 1-2 is disposed on or proximate to the head, and where the head has moved from a position shown in FIG. 5 such that an angle is formed between a median plane of the head and an axis that extends between the head of the wearer and the acoustic source.

FIG. 7 is a schematic diagram of the head of the wearer in relation to the acoustic source and the ambient noise source, where the ear-wearable electronic device system of FIGS. 1-2 is disposed on or proximate to the head, and where the system includes an optional pair of glasses worn by the wearer having eye sensors connected to the glasses.

FIG. 8 is a schematic diagram of the head of the wearer in relation to the acoustic source and the ambient noise source, where the ear-wearable electronic device system of FIGS. 1-2 is disposed on or proximate to the head, and where the system includes an pair of glasses worn by the wearer having eye sensors and an optional camera connected to the glasses.

FIG. 9 is a schematic diagram of the head of the wearer in relation to the acoustic source and the ambient noise source, where the ear-wearable electronic device system of FIGS. 1-2 is disposed on or proximate to the head.

FIG. 10 is a flowchart of one embodiment of a method that can be utilized with the ear-wearable electronic device system of FIGS. 1-2.

### DETAILED DESCRIPTION

In general, the present disclosure provides various embodiments of an ear-wearable electronic device system. The system can include first and second hearing devices each configured to be disposed on or in an ear of the wearer. Each hearing device can also include a microphone or microphone array that is configured to sense acoustic waves from an environment of the wearer and convert the sensed acoustic waves to an audio signal. A controller of the system can be operatively coupled to the first and second hearing devices and can be configured to determine whether a present head orientation of the wearer relative to speech and one or more noise sources corresponds to an optimal head orientation based on scene analysis also determined by the controller. If the present head orientation does not correspond to the optimal head orientation, then the controller is further configured to initiate a prompt to instruct the wearer to turn the head to the optimal head orientation. The prompt can include any suitable indicator that suggests to the wearer to turn the head to the optimal head position, e.g., at least one of a visual signal, an auditory signal, or a haptic signal. The optimal head position can improve the intelligibility of acoustic information that is directed from the acoustic source to the wearer.

In noisy environments, conversation can be difficult to understand, especially for the hearing impaired. Intelligibility of speech can, however, be improved in some situations if the hearing-impaired individual turns the head in an orientation away from facing a target acoustic source. See Grange et al.

When listening to speech in background noise with two ears, it is typical that one ear is acoustically favored (i.e., the “better ear” in that it receives the best signal to noise ratio (SNR)); whereas the other ear is acoustically penalized as it receives the worst SNR (i.e., the “poorer ear”). In such situations, normal-hearing individuals often attend to their better ear (a strategy called “better ear listening”) and ignore the noisier signal arriving at the poorer ear.

An instinctive head turn that brings the better ear closer to the target acoustic source and moves the poorer ear further into the acoustic shadow of the head, thereby increasing the SNR differential between the ears, can be an effective listening strategy. In typically noisy and reverberant social settings such as restaurants, this listening strategy has been shown to improve SNR by around 2 dB. See Grange et al. The improvement can be much higher in less noisy and reverberant environments, e.g., up to 16 dB for normally-hearing individuals in an anechoic environment when speech is directly in front and noise in the opposite direction.

Further, normal-hearing individuals can benefit from the addition of information from the poorer ear through binaural unmasking, i.e., squelch. This benefit, however, can be diminished by spatially distributed noise and reverberation typically encountered in noisy social settings. This is especially true for hearing-impaired individuals, who typically achieve less binaural unmasking than their normal-hearing counterparts in acoustic situations where binaural unmasking is possible. This is because the impaired auditory brain has a reduced ability to exploit the binaural cue that enables binaural unmasking, namely interaural level differences.

Most asymmetrically hearing-impaired individuals are aware that one of their ears hears better than the other (whether aided or not). As a result, they might be more likely to turn their better-hearing ear towards the target acoustic source while they look sidelong at the source’s face to maintain lipreading. While this asymmetry in their hearing may have prompted them to exploit the acoustic benefit of head orientation, they may not exploit it optimally. Those hearing-impaired individuals that are symmetrically impaired may be the ones that would benefit most from being prompted by a hearing device to exploit the head-orientation benefit.

Ear-wearable electronic devices such as hearing aids can be programmed with features to assist a wearer in positioning the wearer’s head in an optimal head position. For example, when a signal-to-noise ratio differential between ears of the wearer is detected and/or directions of a target and interfering sound sources is estimated by the electronic device, actions can be recommended by the device to the wearer that assist the wearer in optimizing listening through the wearer’s better ear, e.g., by prompting the wearer to turn the head towards the optimal head orientation. Such prompt may employ any suitable stimulation modality, e.g., visual, auditory, haptic, etc. For example, the electronic device can prompt the wearer to make a modest head turn away from directly facing the acoustic source to improve intelligibility of acoustic information from the source that the wearer wishes to attend to.

Further, a wearer that has been diagnosed as suffering from contralateral interference may benefit from a reduction in gain in their poorer (hearing) ear, irrespective of whether the wearer utilizes head orientation to improve a signal-to-noise ratio (SNR) at the better ear. This benefit will likely increase as the background noise level increases, such that a reduction of the signal provided at the poorer ear could be made dependent on the noise level alone.

One or more embodiments of ear-wearable electronic device systems described herein can be configured to assist better ear listening. For example, a controller of an ear-wearable electronic device system can be configured to detect when a target acoustic source is not directly in front of a wearer’s head and where in space interfering sounds come from. For instance, beamforming with two or more microphones of the system can be combined with signal analysis to establish both whether a signal contains speech information and the direction from which such a signal arrives at the ears. Further, a combination of techniques can help improve the assessment of the acoustic environment and confirm that it is conducive to assisting listening through the better ear.

For example, one or more embodiments of an ear-wearable electronic device system can analyze a signal arriving at a first hearing device and a second hearing device of the system to determine to what extent the signal-to-noise ratios (SNRs) differ between ears. A controller of the system can establish that the wearer may benefit from turning the head one way or another to maximize SNR in one or the other ear. Based on such analysis, the controller can signal the wearer which way the head should be turned to improve intelligibility of the dominant talker in the acoustic scene. In one or more embodiments, the dominant talker may be placed in the rear hemifield. Typically, this would mean that the dominant talker is not the talker of interest. A talker of interest is typically placed in the frontal hemifield since the wearer often needs to read lips of the talker of interest.

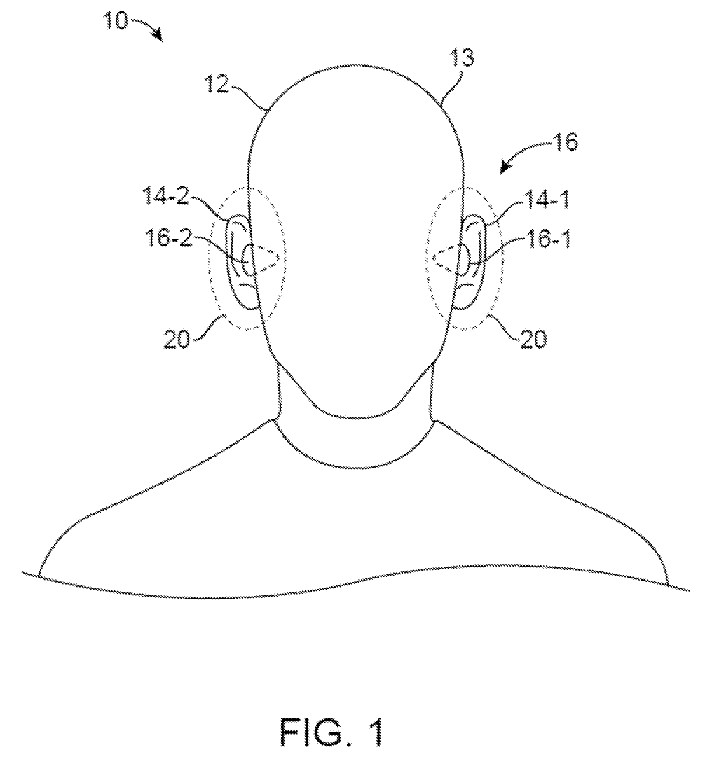

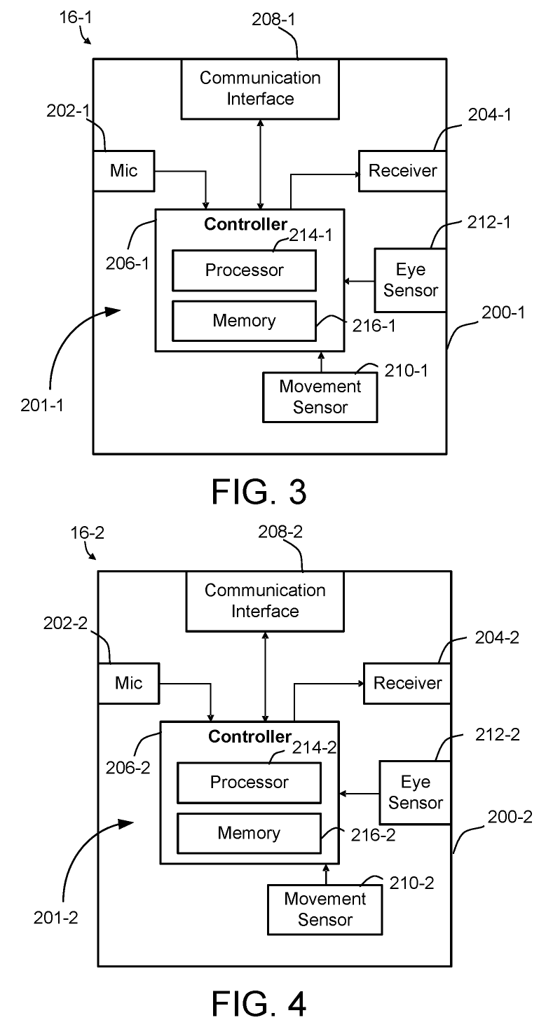

FIGS. 1-4 are various views of one embodiment of an ear-wearable electronic device system 10 disposed on or proximate to a wearer 12. The system 10 includes a first hearing device 16–1 and a second hearing device 16–2 (collectively referred to herein as hearing device or hearing devices 16). Although depicted as including first and second hearing devices 16, the system 10 can include any suitable number of hearing devices, e.g., one, two, three, four, or more hearing devices. The first hearing device 16–1 is configured to be disposed on or in a first ear 14–1 of the wearer 12, and the second hearing device 16–2 is configured to be disposed on or in a second ear 14–2 of the wearer (the first and second ears are collectively referred to herein as ear or ears 14). The first hearing device 16–1 includes a microphone 202–1 (FIG. 3) that is configured to sense acoustic waves from an environment of the wearer 12 and convert the sensed acoustic waves to a first audio signal. And the second hearing device 16–2 includes a microphone 202–2 that is configured to sense acoustic waves from the environment of the wearer 12 and convert the sensed acoustic waves to a second audio signal. The first microphone 202–1 and the second microphone 202–2 are collectively referred to herein as microphone or microphones 202.

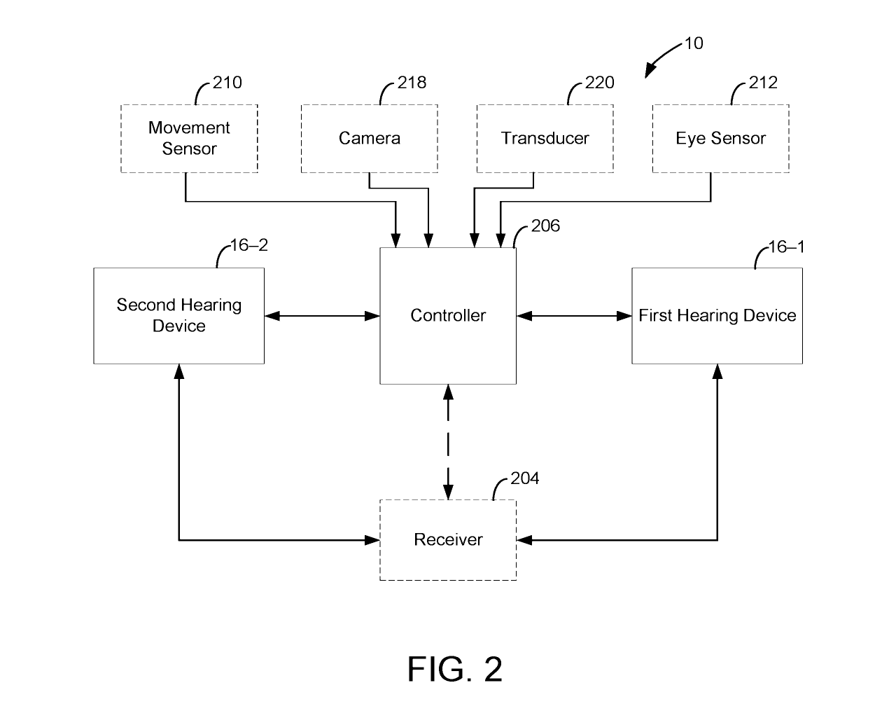

The hearing device system 10 can also include a controller 206 (FIG. 2) operatively coupled to the first and second hearing devices 16 and that includes one or more processors (processors 214–1 and 214–2 of FIG. 3). The controller 206 can be configured to receive first audio information based on the first audio signal and receive second audio information based on the second audio signal, determine a scene analysis based on at least one of the first audio information or the second audio information, and determine whether a present head orientation of the wearer 12 relative to speech and one or more noise sources corresponds to an optimal head orientation based on the scene analysis. The controller 206 is further configured to initiate a prompt to instruct the wearer 12 to turn the head 13 to the optimal head orientation if the present head orientation does not correspond to the optimal head orientation. The present head orientation does not correspond to the optimal head orientation if the present head orientation is not substantially equal to the optimal head orientation.

Each hearing device 16 can include any suitable components or circuitry. As shown in FIG. 3, the first hearing device 16–1 can include the microphone 202–1 that is configured to sense acoustic waves from an environment of the wearer 12 and convert the sensed acoustic waves to a first audio signal. Further, as shown in FIG. 4, the second hearing device 16–2 can also include the microphone 202–2 that is configured to sense acoustic waves from the environment of the wearer 12 and convert the sensed acoustic waves to a second audio signal. Each hearing device 16 can include any suitable number of microphones. In one or more embodiments, the microphone 202–1 of the first hearing device 16–1 can include a microphone array of two or more microphones, and the microphone 202–2 of the second hearing device 16–2 can include a microphone array of two or more microphones.

As illustrated in FIG. 1, each hearing device 16 can be worn proximate, or adjacent to, the pinna or worn in one or both ears 14 of wearer 12. In one or more embodiments, each hearing device 16 is positioned, at least partially, in each ear 14. In one or more embodiments, each hearing device 16 is positioned in a region or zone 20 around each ear 14. Various embodiments of hearing devices 16 of system 10 can also include sensors, such as a movement sensor or microphone, disposed outside such zone 20 or within the zone 20, or such sensors can be positioned on headbands going over the head, on neckbands behind the head, or on cords connected to other devices. Such sensors can be connected to one or more hearing devices 16 either wirelessly using any suitable technique or by a wired connection.

The hearing devices 16 can include any suitable device that can be utilized to provide acoustic energy to the wearer 12, e.g., a hearing assistance device, an earphone, or a headphone (e.g., earbud). Further, each hearing device 16 can include any suitable circuitry or components, e.g., a receiver, one or more sensors, such as a motion detector, a microphone, a heart rate sensor, or an electrophysiological sensor, etc., as is further described herein.

The hearing devices 16 can include at least one hearing assistance device. Any suitable hearing assistance device can be utilized, e.g., behind-the-ear (BTE), in-the-ear (ITE), in-the-canal (ITC), receiver-in-canal (RIC), completely-in-the-canal (CIC), or invisible-in-the-canal (IIC)-type hearing aids. It is understood that BTE type hearing assistance devices can include devices that reside substantially behind the ear or over the ear. Such devices can include hearing aids with receivers associated with the electronics portion of the device or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard, open fitted, or occlusive fitted. The present subject matter can additionally be used in consumer electronic wearable audio devices having various functionalities. It is understood that other devices not expressly stated herein can also be used with the present subject matter.

As shown in FIGS. 3-4, the first hearing device 16–1 can include one or more electronic components 201–1 disposed on or at least partially within a housing 200–1, and the second hearing device 16–2 can include one or more electronic components 201–2 disposed on or at least partially within a housing 200–2 (electronic components 201–1 and 201–2 are collectively referred to herein as electronic component or components 201, and housings 200–1 and 200–2 are collectively referred to herein as housing or housings 200). The electronic components 201 can be disposed in any suitable location or arrangement within the housing 200. In one or more embodiments, one or more of the electronic components 201 can be disposed at least partially within the housing 200, on the housing, or external to the housing.

The electronic components 201 can include any suitable circuits or devices, e.g., integrated circuits, power sources, microphones, receivers, sensors, etc. For example, in one or more embodiments, the components 201 can include one or more of the controller 206, the microphone 202, a receiver (e.g., speaker) 204, a power source (not shown), an antenna (e.g., a communication interface 208), or various other sensors (e.g., movement sensor 210, heart rate sensor, eye sensor 212, or electrophysiological sensor). The electronic component 201 can be electrically connected to the controller 206 using any suitable technique.

In the illustrated embodiment, the first hearing device 16–1 includes the microphone 202–1, a receiver 204–1, the controller 206–1, a communication interface 208–1, a movement sensor 210–1, and an eye sensor 212–1. Further, the second hearing device 16–2 includes the microphone 202–2, a receiver 204–2, the controller 206–2, a communication interface 208–2, a movement sensor 210–2, and an eye sensor 212–2.

Each microphone 202–1 and 202–2 can be electrically connected to the respective controller 206–1, 206–2. Although each hearing device 16 includes one microphone 202–1, 202–2 respectively, the components 201 can include any suitable number of microphones. In one or more embodiments, a port or opening can be formed in the housing 200, and the microphone 202 can be disposed adjacent the port to receive audio information from the wearer’s ambient acoustic environment. In one or more embodiments, the microphone 202 is configured to sense acoustic waves from the environment of the wearer 12 and convert the sensed acoustic waves to an audio signal.

Operatively coupled to the first and second hearing devices 16–1, 16–2 is the controller 206. The system 10 can include any suitable number of controllers 206. As shown in FIG. 2, the controller 206 can be operably coupled to at least one of the first hearing device 16–1, the second hearing device 16–2, the receiver 204, the movement sensor 210, the eye sensor 212, a camera 218, or one or more additional devices or components. In one or more embodiments, the system 10 can also include a transducer 220 that can be configured to direct a prompt to the wearer 12 that instructs the wearer to turn the head to the optimal head orientation as is described herein.

The controller 206 can be disposed in any suitable position relative to the wearer 12. In one or more embodiments, the controller 206 can be disposed in an external device or system and operatively connected to at least one of the first hearing device 16–1, the second hearing device 16–2, the receiver 204, the movement sensor 210, the eye sensor 212, the camera 218, or other devices or components of the system 10 by a wired or wireless connection. In one or more embodiments, the controller 206 can be disposed on or at least partially within at least one of the housing 200–1 of the first hearing device 16–1 or the housing 200–2 of the second hearing device 16–2.

For example, as shown in FIGS. 3 and 4, the controller 206 includes the first controller 206–1 disposed on or at least partially within the housing 200–1 of the first hearing device 16–1 and the second controller 206–2 disposed on or at least partially within the housing 200–2 of the second hearing device 16–2 (collectively referred to herein as controller or controllers 206). In the illustrated embodiments, the first controller 206–1 includes a processor 214–1 and memory 216–1, and the second controller 206–2 includes a processor 214–2 and memory 216–2.

In general, the controller 206 can include a digital signal processor (DSP), microprocessor, microcontroller, other digital logic, or combinations of these. Processing can be done by a single processor or can be distributed over different devices. For example, the processing of signals can be performed using controller 206 or over different devices. Processing can be done in the digital domain, the analog domain, or combinations thereof. In one or more embodiments, processing can be done using subband processing techniques. Processing can be done using frequency domain or time domain approaches. Some processing can involve both frequency and time domain aspects. For brevity, in some examples, drawings can omit certain blocks that perform frequency synthesis, frequency analysis, analog-to-digital conversion, digital-to-analog conversion, amplification, buffering, and certain types of filtering and processing. In one or more embodiments, processors 214–1 and 214–2 or other processing devices execute instructions to perform a number of signal processing tasks. Such embodiments can include analog components in communication with processors 214–1 and 214–2 to perform signal processing tasks, such as sound reception by microphones 202 or playing of sound using receiver 204.

The processors 214–1 and 214–2 (collectively referred to herein as processors 214) of the controllers 206–1 and 206–2 can include any one or more of a microprocessor, a microcontroller, a digital signal processor (DSP), an application specific integrated circuit (ASIC), a field-programmable gate array (FPGA), and/or equivalent discrete or integrated logic circuitry. In one or more embodiments, the processors 214 can include multiple components, such as any combination of one or more microprocessors, one or more controllers, one or more DSPs, one or more ASICs, and/or one or more FPGAs, as well as other discrete or integrated logic circuitry. The functions attributed to the controller 206 or processor 214 herein can be embodied as software, firmware, hardware, or any combination thereof. While described herein as a processor-based system, an alternative controller can utilize other components such as relays and timers to achieve the desired results, either alone or in combination with a microprocessor-based system.

In one or more embodiments, the exemplary systems, methods, and interfaces can be implemented using one or more computer programs using a computing apparatus, which can include one or more processors and/or memory. Program code and/or logic described herein can be applied to input data/information to perform functionality described herein and generate desired output data/information. The output data/information can be applied as an input to one or more other devices and/or methods as described herein or as would be applied in a known fashion. In view of the above, it will be readily apparent that the controller functionality as described herein can be implemented in any manner known to one skilled in the art.

In one or more embodiments, the system 10 can further include the receiver 204 (FIG. 2) operatively coupled to one or both of the first hearing device 16–1 and the second hearing device 16–2. The receiver 204 can be configured to be in fluid communication with at least one of the first ear 14–1 or the second ear 14–2, and output acoustic energy based on a receiver signal provided by the controller 206. The receiver 204 (e.g., at least one of receiver 204–1 of the first hearing device 16–1 or receiver 204–2 of the second hearing device 16–2) can include any suitable receiver or speaker and can be electrically connected to the controller 206 (e.g., at least one of controller 206–1 of first hearing device 16–1 or controller 206–2 of the second hearing device 16–2) using any suitable technique. Further the receiver 204 can be in fluid communication with one or both ears 14. As used herein, the term “fluid communication” means that the receiver 204 is disposed such that it can send and receive acoustic information to and from at least one of the first ear 14–1 or second ear 14–2. The receiver 204 can also be referred to as a speaker. Further, the receiver 204 can be operatively coupled to one or both of the first hearing device 16–1 and the second hearing device 16–2. In one or more embodiments, acoustic information can be transmitted to one or both ears 14 using other suitable techniques, e.g., an ear-lens system, energy transduction via electrical stimulation of the auditory nerve utilizing a cochlear implant, bone conduction, direct transmission to the oval window of the cochlea, etc.

The receiver 204 can be in fluid communication with the first ear 14–1 and the second ear 14–2 using any suitable technique. The receiver 204 can further be configured to output acoustic energy based on a receiver signal provided by the controller 206 based on at least one of the first audio signal or second audio signal. In one or more embodiments, the receiver 204 is adapted to convert the receiver signal from the controller 206 to an acoustic output or sound that can be transmitted from at least one of the first hearing device 16–1 or the second hearing device 16–2 to the wearer 12. For example, in hearing applications, receiver 204 can be an amplified version of an audio or microphone signal received from one or both microphones 202.

The system 10 can include any suitable number of receivers 204 disposed in any suitable position or location relative to the wearer 12. The receiver 204 is operatively coupled to one or both of the first hearing device 16–1 and the second hearing device 16–2. In one or more embodiments, the receiver 204 can be disposed within a housing of a BTE device, and acoustic energy produced by the receiver can be directed to one or both ears 14 of the wearer 12 by a cable or tube that connects the BTE housing to an earpiece. In one or more embodiments, the receiver 204 can be disposed on or at least partially within either the first hearing device 16–1 or the second hearing device 16–2. In one or more embodiments, the receiver 204 can include the first receiver 204–1 disposed on or at least partially within the housing 200–1 of the first hearing device 16–1 and the second receiver 204–1 disposed on or at least partially within the housing 200–2 of the second hearing device 16–2 as shown in FIGS. 3 and 4.

The system 10 can also include one or more movement sensors 210 (FIG. 2) operatively connected to the controller 206 using any suitable technique. The movement sensor 210 can be configured to detect motion of the head 13 of the wearer 12 and provide a movement signal to the controller 206. The system 10 can include any suitable number of movement sensors 210. In one or more embodiments, at least one of the first hearing device 16–1 or second hearing device 16–2 can include the movement sensor 210. For example, as shown in FIGS. 3 and 4, the movement sensor 210 can include a first movement sensor 210–1 of the first hearing device 16–1 and a second movement sensor 210–2 of the second hearing device 16–2. Any suitable movement sensor 210 can be utilized, e.g., an inertial measurement unit (IMU) sensor. The controller 206 can be configured to detect motion of the head of the wearer 12 utilizing the movement sensor 210 and any suitable technique. In one or more embodiments, the movement sensor 210 can be configured to provide the head movement signal to the controller 206 using any suitable technique.

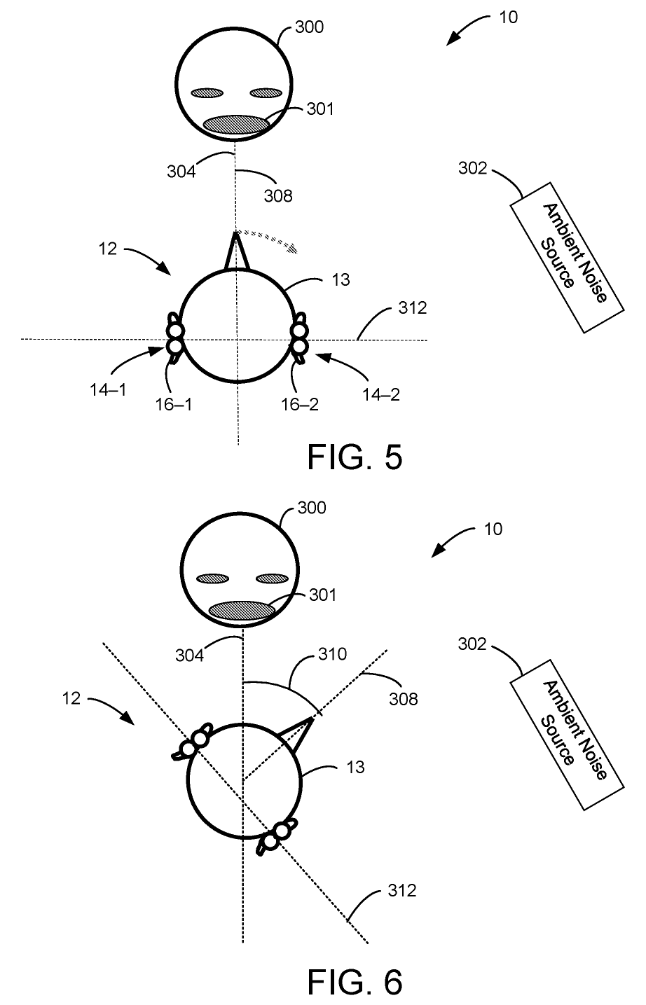

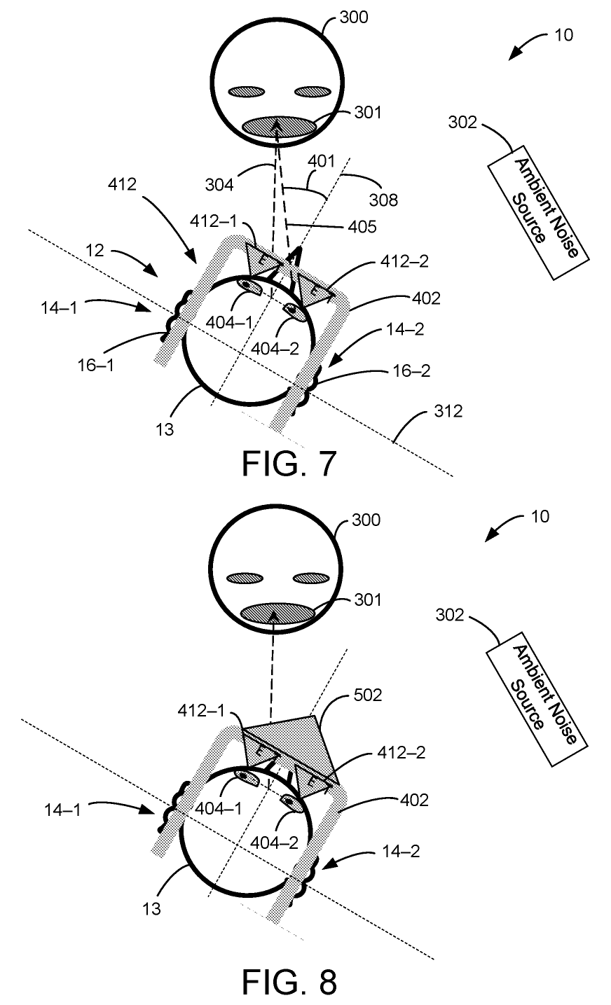

Further, in one or more embodiments, the system 10 can include an eye sensor or sensor array 212 (FIG. 2) that is operatively connected to the controller 206 using any suitable technique. The eye sensor 212 can be configured to detect a position of at least one eye (e.g., at least one first eye 404–1 or second eye 404–2 of FIG. 7) of the wearer 12 relative to a median plane (e.g., median plane 308 of FIG. 5) of the head 13 of the wearer 12 and provide an eye position signal to the controller 206 using any suitable technique. In one or more embodiments, one or more of the eye sensors 212 can include an optical sensor that is configured to track a position of the eye (e.g., pupil) in its socket. In one or more embodiments, one or more of the eye sensors 212 can be configured to track movement of the eye by sensing eye muscle activation via electromyography sensing. The eye sensor 212 can include any suitable device or component that can detect eye movement of the wearer 12. Further, the eye sensor 212 can be disposed in any suitable location relative to the wearer 12. In one or more embodiments, the eye sensor 212 can be associated with at least one of the first hearing device 16–1 or second hearing device 16–2. The system 10 can include any suitable number of eye sensors 212. For example, as shown in FIG. 3, the eye sensor 212 includes a first eye sensor 212–1 of hearing device 16–1 operatively connected to controller 206–1 and a second eye sensor 212–2 of the second hearing device 16–2 operatively connected to controller 206–2.

As mentioned herein, the system 10 can further include the camera 218 (FIG. 2) operatively connected to the controller 206 using any suitable technique. The camera 218 can include any suitable camera or cameras and be disposed in any suitable position relative to the head 13 of the wearer 12. Further, the system 10 can include any suitable number of cameras 218. Although not shown, in one or more embodiments, the first hearing device 16–1 can include a first camera, and the second hearing device 16–2 can include a second camera. The first camera can be operatively connected to the first controller 206–1 and the second camera can be operatively connected to the second controller 206–2. In one or more embodiments, the camera 218 can be disposed on glasses (e.g., glasses 402 of FIG. 8) that can be worn by the wearer 12. In one or more embodiments, the camera 218 can be configured to provide an image signal to the controller 206 using any suitable technique. The controller 206 can further be configured to determine whether a present head orientation of the wearer 12 relative to speech and one or more noise sources corresponds to an optimal head orientation using any suitable technique. For example, such determination can be made by the controller 206 based upon the scene analysis.

The system 10 can further include the transducer 220 (FIG. 2) that can be configured to direct a prompt to the wearer 12 that instructs the wearer to turn the head to the optimal head orientation as is described herein. The prompt can include any suitable signal, e.g., at least one of a visual signal, an auditory signal, or a haptic signal. For delivery of a visual signal, the transducer 220 can include one or more light sources that are disposed, e.g., on glasses 402 of FIGS. 7–8 as is further described herein. Further, for delivery of an auditory signal, the transducer 220 can include one or more speakers (e.g., receiver 204) disposed, e.g., in at least one of the first or second hearing devices 16–1, 16–2. The speaker can be the receiver 204 or one or more additional speakers. And for delivery of a haptic signal, the transducer 220 can include a haptic transducer that can be disposed, e.g., in at least one of the first or second hearing devices 16–1, 16–2 and/or on glasses 402 and can be configured to direct vibratory energy to the wearer 12.

The controller 206 may then establish that the wearer 12 may benefit from turning the head 13 one way or another to maximize SNR in one or the other ear 14. Based on such analysis, the controller 206 may initiate a prompt to the wearer 12 that indicates a direction that the wearer can turn the head to improve the intelligibility of the dominant speaker.

For example, the controller 206 can be configured to receive first audio information based on the first audio signal and receive second audio information based on the second audio signal. As used herein, the terms “first audio information” and “second audio information” mean information that can be determined by the controller 206 from the audio signals provided by at least one of the first or second microphones 202–1, 202–2. First and second audio information can include any environmental sound, e.g., speech, music, alarms or noises, etc.

The controller 206 can further be configured to determine a scene analysis of the wearer’s environment based on at least one of the first audio information or the second audio information using any suitable technique. As used herein, the phrase “scene analysis” means computational analysis that can determine a direction of arrival with respect to the wearer’s head of all or most relevant sound sources contributing to audio information in the wearer’s environment. For example, the controller 206 can be configured to determine the scene analysis by performing one or more of, e.g., comparing a first signal to noise ratio (SNR1) of the first audio information and a second signal to noise ratio (SNR2) of the second audio information, determining a presence of speech, determining a direction of arrival of speech, determining a direction of arrival of noise, etc. The various steps or components of scene analysis may be carried out or performed using any suitable methods, techniques, and/or algorithms.

Any suitable technique can be utilized to compare SNR1 and SNR2. For example, SNR1 and SNR2 can be compared by determining a difference (delta SNR) between SNR1 and SNR2. In one or more embodiments, scene analysis can be performed utilizing any suitable machine learning method. For example, the presence of speech may be determined using a speech probability detector. The speech probability detector may include one or more, e.g., Bayesian classifiers, machine learning models, neural networks, statistical models, etc. See, e.g., one or more embodiments of speech probability detectors described in U.S. Patent Application Serial No. 63/683,301 to Betlehem et al., filed August 15, 2024, and entitled HEARING DEVICE WITH NEURAL NETWORK SPEECH DETECTOR. Any suitable technique can be utilized to determine direction of arrival of speech, e.g., one or more techniques described in U.S. Application Serial No. 63/679,827 to Pollak et al., filed August 6, 2024, and entitled HEARING DEVICE WITH MACHINE LEARNING MODEL TO DETERMINE DIRECTION OF ARRIVAL.

FIGS. 5-6 are diagrammatic views of the head 13 of the wearer 12 relative to an acoustic source 300 and an ambient noise source 302. As shown in FIG. 5, the wearer 12 is facing the acoustic source 300 such that a median plane 308 of the head 13 of the wearer 12 is directed to the acoustic source. As used herein, the term “median plane” refers to a plane 308 that is orthogonal to a line between the first ear 14–1 and the second ear 14–2 of the wearer (i.e., the interaural axis 312). In this orientation, the wearer 12 can be considered to be facing the acoustic source 300 such that an angle 310 (FIG. 6) between the median plane 308 and an axis 304 that extends between the head 13 of the wearer 12 and the acoustic source is equal to about 0 degrees. FIGS. 5-6 further illustrate the ambient noise source 302 that provides ambient noise that can make it challenging for the wearer 12 to hear the acoustic source 300 or understand acoustic information being transmitted by the source.

The controller 206 can be configured to determine the optimal head orientation of the head 13 of the wearer 12 using any suitable technique. Such optimal head orientation can provide the greatest SNR in either the first ear 14–1 or the second ear 14–2. The optimal head orientation can be defined by the angle 310 between the median plane 308 and the axis 304. In one or more embodiments, the optimal head orientation can be determined based upon the greatest SNR in an ear 14 and the ability for the wearer 12 to still view lips 301 of the acoustics source 300 if the source is a speaker. Such angle 310 can include any suitable angle. In one or more embodiments, the optimal head orientation forms an angle 310 of between minus 45 degrees and plus 45 degrees. As shown in FIG. 6, the head 13 of the wearer 12 has rotated such that the angle 310 between the axis 304 and the median plane 308 of the head is greater than 0 degrees.

The controller 206 can further be configured to initiate a prompt to instruct the wearer 12 to turn the head 13 to the optimal head orientation if the present head orientation is not substantially equal to the optimal head orientation using any suitable technique. As used herein, the term “substantially equal” means that an angle between the median plane 308 of the head 13 of the wearer 12 when the head is in the optimal head orientation and the median plane when the head is in the present head orientation is no greater than 5 degrees. In other words, the present head orientation of the wearer 12 relative to speech and one or more noise sources corresponds to the optimal head orientation if the angle between the median plane 308 of the head 13 when in the present head orientation and the median plane of the head when in the optimal head orientation is no greater than 5 degrees.

The prompt can be any suitable prompt that is configured to notify the wearer 12 that moving the head 13 relative to the acoustic source 300 in a particular direction may provide improved understanding of acoustic information produced by the source. For example, the prompt can be at least one of a visual signal, an auditory signal, or a haptic signal. The visual signal can be produced by one or more light sources disposed, e.g., on glasses 402 (FIG. 7) worn by the wearer 12. For example, a light source disposed adjacent to the second ear 14–2 within view of the second eye 404–2 of the wearer 12 can produce light that indicates that the wearer 12 may benefit from turning the head 13 clockwise (as view in the plane of FIGS. 5-6) such that the first ear 14–1 is closer to the acoustic source 300.

The auditory signal can be produced by the receiver 204 based on a receiver signal provided by the controller 206. For example, the second receiver 204–2 associated with the second hearing device 16–2 can produce acoustic energy that indicates to the wearer 12 that a clockwise rotation of the head 13 may provide improved reception (i.e., reduced SNR) of the acoustic information from the acoustic source 300. The auditory signal can include any suitable acoustic information, e.g., a tone or tones, a spoken word or message, etc.

Further, the haptic signal can include any sensation directed to the wearer 12 that indicates that the rotation of the head 13 may provide improved intelligibility of acoustic information from the acoustic source 300. For example, a haptic transducer or transducers may be disposed in one or both of the hearing devices 16 that is configured to provide a haptic signal to the wearer 12. In one or more embodiments, one or more haptic transducers can be disposed, e.g., on the glasses 402 (FIG. 7) worn by the wearer 12 that can provide such haptic signal.

The controller 206 can also be configured to provide the receiver signal to the receiver 204 based on at least one of the first audio signal or second audio signal from the microphones 202 of the first and second hearing devices 16–1 and 16–2. Further, the controller 206 can be configured to determine the first signal to noise ratio (SNR1) of the first audio signal, determine the second signal to noise ratio (SNR2) of the second audio signal, and compare SNR1 and SNR2. Further, the controller 206 can be configured to modify the receiver signal based on a difference (delta SNR) between SNR1 and SNR2.

The controller 206 can be configured to use any suitable technique to determine whether to modify the receiver signal. For example, the controller 206 can be configured to modify the receiver signal if the difference between SNR1 and SNR2 (i.e., delta SNR = |SNR1-SNR2|) is greater than a signal to noise ratio difference threshold (SNRT). Any value of SNRT can be selected. In one or more embodiments, the SNRT can be at least 1 dB and no greater than 30 dB.

Further, the controller 206 can be configured to modify the receiver signal using any suitable technique. In one or more embodiments, the controller 206 can be configured to modify the receiver signal by increasing a gain in the receiver signal of either the first audio signal or the second audio signal having the greatest signal to noise ratio. For example, if the first audio signal from the microphone 202–1 of the first hearing device 16–1 has an SNR1 that is greater than SNR2 from the microphone 202–2 of the second hearing device 16–2, then a gain of the first audio signal can be increased in the receiver signal provided to at least one of the first ear 14–1 or second ear 14–2.

Further, for example, the controller 206 can be configured to modify the receiver signal by decreasing a gain in the receiver signal of either the first audio signal or second audio signal having the lowest or least signal to noise ratio. For example, if the first audio signal from the microphone 202–1 of the first hearing device 16–1 has an SNR1 that is greater than SNR2 of the second audio signal from the microphone 202–2 of the second hearing device 16–2, then a gain of the second audio signal can be decreased in the receiver signal provided to at least one of the first ear 14–1 or second ear 14–2.

The controller 206 can also be configured to modify the receiver signal by providing in the receiver signal either the first audio signal or second audio signal having the greatest signal to noise ratio to each of the first ear 14–1 and second ear 14–2. For example, if the first audio signal from the microphone 202–1 of the first hearing device 16–1 has an SNR1 that is greater than an SNR2 from the microphone 202–2 of the second hearing device 16–2, then the first audio signal can be provided in the receiver signal directed to each of the first ear 14–1 or second ear 14–2.

The controller 206 can also be configured to determine a preferred ear of the wearer using any suitable technique, e.g., one or more of the techniques described in U.S. Patent Application Serial No. 63/609,959 to Grange et al., filed December 14, 2023, and entitled CONTRALATERAL-HEARING INTERFERENCE REDUCTION. For example, the controller 206 can be configured to determine the preferred ear by identifying which of the first audio signal or second audio signal has the greatest signal to noise ratio. As most wearers instinctively rotate their heads such that the preferred ear is directed toward the acoustic source, the signal to noise ratio of the audio signal provided by the microphone of the hearing device disposed in the ear that is directed toward the target would likely have the greatest signal to noise ratio. Such ear would then likely be considered the preferred ear.

As shown in FIG. 6, the wearer 12 has turned the head 13 such that the angle 310 between the median plane 308 and the axis 304 is greater than 0 degrees. Angle 310 can be any suitable value, e.g., between minus 45 degrees and plus 45 degrees. Because of this turn of the head 13, the first ear 14–1 is now disposed closer to the acoustic source 300 than the second ear 14–2. In one or more embodiments, the controller 206 can be configured to determine whether the wearer 12 turned the head 13 from the present head orientation to the optimal head orientation following the initiated prompt. Any suitable technique can be utilized to make this determination, e.g., an increase in SNR of the signal at the first ear 14–1. In one or more embodiments, this determination can be based on an increased SNR difference that is greater than or equal to a selected threshold (e.g., 2 dB). Further, in one or more embodiments, this determination can be based on a shift of the direction of arrival of speech and/or noise. For example, a single noise source and/or sound source can be selected that has a determined direction of arrival, and a shift of 15–45 degrees between this direction of arrival and the median plane 308 of the wearer 12 can indicate that the wearer has turned the head 13 from the present head orientation to the optimal head orientation. The controller 206 can also be configured to determine whether further prompting should occur.

For example, the system 10 can further include the movement sensor 210 (FIG. 2) as described herein. The controller 206 can be configured to detect motion of the head of the wearer 12 utilizing the movement sensor 210 and using any suitable technique. In one or more embodiments, the movement sensor 210 can be configured to provide a movement signal to the controller 206 using any suitable technique. The controller 206 can, therefore, be configured to determine whether the wearer 12 has turned the head 13 from the present head orientation (FIG. 5) to the optimal head orientation based on this movement signal from the movement sensor 210.

For example, the system 10 can determine whether the wearer 12 has turned the head 13 from the present head orientation to the optimal head orientation based on information from the eye sensor 212 (FIG. 2). Such eye sensor 212 can be operatively connected to the controller 206 using any suitable technique. The eye sensor 212 can include any suitable device or component that can detect a position of at least one eye of the wearer relative to the median plane 308 of the head 13 and provide an eye position signal to the controller 206. Further, the eye sensor 212 can be disposed in any suitable location relative to the wearer 12.

In one or more embodiments, the ear-wearable electronic device system 10 can include a pair of glasses 402 that can be worn by the wearer 12 that includes one or more eye sensors 212 as shown in FIG. 7. The glasses 402 can include any suitable glasses or other headgear that can include any suitable lenses, e.g., corrective lenses, polarizing lenses, etc. The glasses 402 can further include one or more eye sensors 412 disposed on or at least partially within any suitable portion or portions of the glasses 402, e.g., in front of eyes 404 of the wearer 12 such that the sensors can detect a position of at least one eye of the wearer relative to the median plane 308 of the head 13 and provide an eye position signal to the controller 206. Each eye sensor 412 can include any suitable eye sensor, e.g., eye sensor 212 of FIG. 2. As shown in FIG. 7, a first eye sensor 412–1 is configured to detect a position of a first eye 404–1 of the wearer 12 relative to the median plane 308 of the head 13, and a second eye sensor 412–2 is configured to detect a position of a second eye 404–2 of the wearer relative to the median plane. The first and second eyes are referred to collectively herein as eyes 404. Further, the first and second eye sensors 412–1 and 412– 2 are referred to collectively herein as eye sensors 412.

The eye sensor or sensors 412 can be configured to detect eye movement of at least one eye 404 of the wearer 12 and provide an eye position signal to the controller 206 using any suitable technique. For example, the controller 206 can be configured to determine an angle 401 between a direction 405 of the eye 404–2 that is looking at the acoustic source 300 and the median plane 308 of the head 13 as shown in FIG. 7. The controller 206 can be configured to track the eye 404 or saccadic eye movements in the direction of attention by measuring eye movement related eardrum oscillations (EMREOs). Such detection can assist in confirming that the wearer 12 is looking sidelong at the acoustic source’s face (to facilitate lip reading) as a result of turning the head 13 away from directly facing the acoustic source 300 as shown in FIG. 7. If such eye movement is not detected, then the wearer 12 may have rotated past an optimal head orientation to a point where the wearer 12 may not be able to see the acoustic source’s lips 301. In such case, the controller 206 can be configured to prompt the wearer 12 using any suitable technique to take corrective action by rotating the head 13 in the opposite direction until the head is in the optimal head orientation.

The various ear-wearable electronic device systems described herein can further include additional sensors or components that can be utilized to track two or more acoustic sources (such as talkers). For example, system 10 can optionally include one or more cameras 502 disposed in any suitable position relative to the wearer 12. The camera 502 can be utilized to track movement of lips 301 of the acoustic source 300 to determine whether the source is speaking. Any suitable camera 502 can be utilized, e.g., camera 218 of FIG. 2. Further, the camera 502 can be disposed on the wearer 12 or on the glasses 402 worn by the wearer. In one or more embodiments, at least one of the camera 502, the movement sensor 210, or the eye sensors 412 can also be utilized to track movement of lips 301 of the acoustic source 300 using any suitable technique. The controller 206 can be configured to receive a camera signal from the camera 502 and determine whether the acoustic source 300 is speaking based on the camera signal. In one or more embodiments, the controller 206 is further configured to determine a target acoustic source 300 based upon identification of lip movement of lips 301 of an audio source detected in the image signal. The controller 206 can further be configured to initiate a prompt to instruct the wearer 12 to turn the head 13 to the optimal head orientation if the present head orientation is not substantially equal to the optimal head orientation, where the controller is further configured to determine the optimal head orientation as an orientation that maximizes speech intelligibility of speech from the acoustic source 300.

If the wearer 12 has not turned the head 13 from the present head orientation to the optimal head orientation following the first initiated prompt, then the controller 206 can be further configured to initiate a second or additional prompts to the wearer to turn the head to the optimal head orientation. The controller 206 can provide any suitable additional prompt or prompts to the wearer, e.g., at least one of a visual signal, an auditory signal, or a haptic signal. Further, the controller 206 can utilize any suitable technique to determine whether the wearer 12 has turned the head 13 to the optimal head orientation.

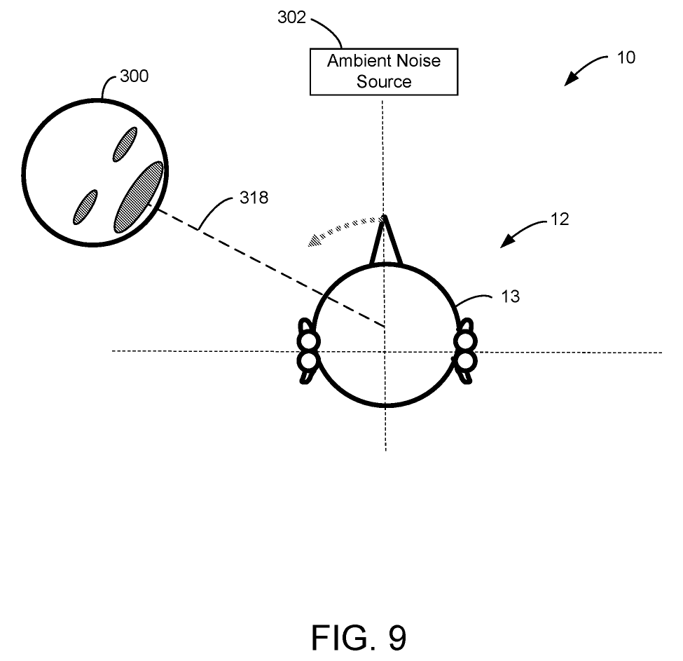

The various embodiments of ear-wearable electronic device systems described herein can also be utilized to prompt the wearer to turn the head toward an acoustic source or target speaker. For example, FIG. 9 is a schematic diagram of the ear-wearable electronic device system 10, where the wearer 12 is facing the ambient noise source 302 and not the acoustic source 300. Any suitable technique can be utilized to determine a direction of arrival 318 of acoustic information from the acoustic source 300. For example, beam shaping or other techniques can be utilized to determine the direction of arrival 318 of the acoustic information from the first audio signal and the second audio signal. In one or more embodiments, scene analysis as described herein can be utilized to determine the direction of arrival 318.

Once the direction of arrival 318 has been determined, the controller 206 can be configured to determine whether a present head orientation of the wearer 12 (FIG. 9) relative to speech from the acoustic source 300 and the ambient noise source 302 corresponds to an optimal head orientation, where the wearer is facing the acoustic source. The controller 206 can then initiate a prompt to instruct the wearer 12 to turn the head 13 to the optimal head orientation (counterclockwise as shown in FIG. 9). Any suitable prompt can be utilized, e.g., at least one of a visual signal, an auditory signal, or a haptic signal.

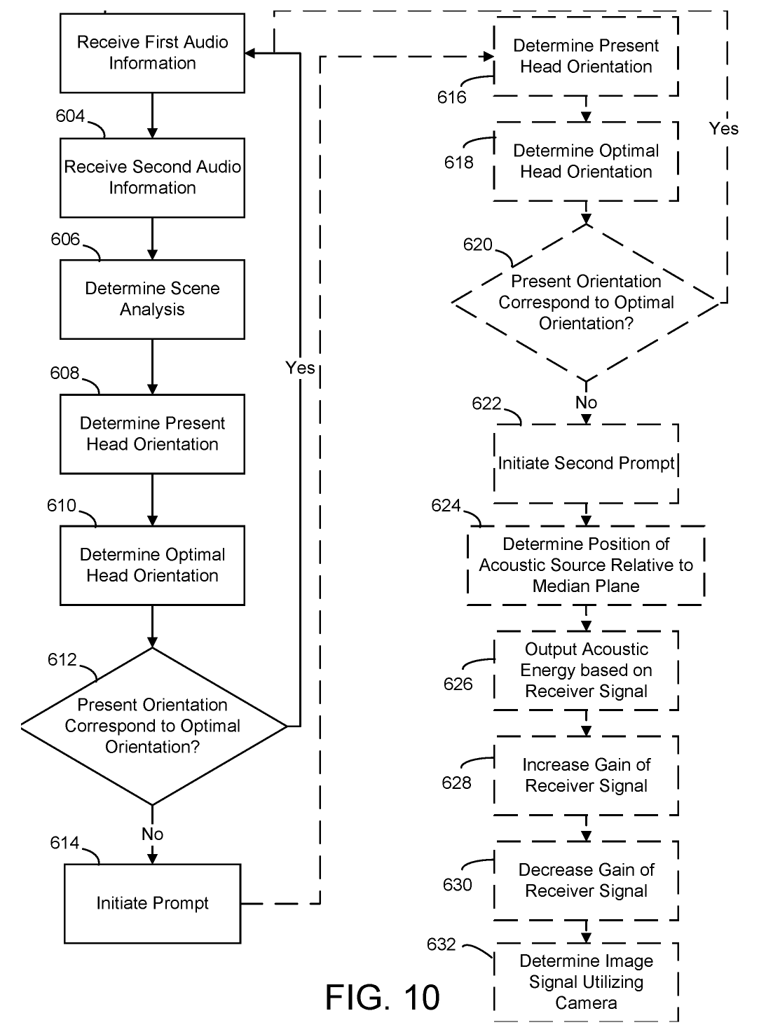

Any suitable technique can be utilized with the various embodiments of ear-wearable electronic device systems described herein to prompt the wearer to rotate the head to an optimal head orientation given the acoustic environment of the wearer. For example, FIG. 10 is a flowchart of one embodiment of a method 600 that can be utilized with the ear-wearable electronic device system 10. Although described regarding system 10, the method 600 can be utilized with any suitable ear-wearable electronic device system.

At 602, first audio information is received, where the first audio information is based on a first audio signal that is converted by the first microphone 202–1 of the first hearing device 16–1 from acoustic waves sensed by the first microphone from the environment of the wearer 12 of the first hearing device. Second audio information is received at 604, where the second audio information is based on the second audio signal that is converted by the second microphone 202–2 of the second hearing device 16–2 from acoustic waves sensed by the second microphone from the environment of the wearer. At 606, the scene analysis can be determined using any suitable technique, where the scene analysis is based on at least one of the first audio information or the second audio information. For example, the scene analysis can be at least partially determined by determining SNR1 of the first audio information, determining SNR2 of the second audio information, and comparing the SNR1 to SNR2 (e.g., delta SNR).

The present head orientation of the head 13 of the wearer 12 relative to speech and one or more noise sources 300, 302 is determined at 608 using any suitable technique. At 610, the optimal head orientation can be determined using any suitable technique. For example, the optimal head orientation can be determined by determining a head orientation that increases at least one of SNR1 or SNR2.

Whether the present head orientation corresponds to the optimal head orientation can be determined at 612 using any suitable technique. In one or more embodiments, such determination can be based on the scene analysis. If the present head orientation corresponds to the optimal head orientation at 612, then the method 600 returns to 602, where first audio information can be received as described herein. If, however, the present head orientation does not correspond to the optimal head orientation at 612, then a prompt to instruct the wearer to turn the head to the optimal head orientation is initiated at 614. In one or more embodiments, the prompt can be initiated by directing at least one of a visual signal, an auditory signal, or a haptic signal to the wearer 12.

At 616, the method 600 can optionally further determine whether the wearer 12 turned the head 13 from the present head orientation to the optimal head orientation after initiating the prompt using any suitable technique. For example, motion of the head 13 of the wearer 12 can be detected using any suitable technique, e.g., the movement sensor 210 can detect movement of the head 13. The movement sensor 210 can provide the movement signal to the controller 206 based on detected motion of the head 13 of the wearer 12. Whether the wearer 12 has turned the head 13 from the present head orientation to the optimal head orientation can be determined based on the movement signal. In one or more embodiments, whether the wearer 12 turned the head 13 from the present head orientation can be determined by detecting a position of at least one eye 404 of the wearer relative to the median plane 308 of the head (FIG. 7). An eye position signal based on the detected position of at least one eye 404 can be provided by one or both eye sensors 412 to the controller 206. A determination of whether the wearer 12 has turned the head 13 from the present head orientation to the optimal head orientation can be made based on the eye position signal.

At 618, the optimal head orientation can optionally be determined using any suitable technique. Further, whether the present head orientation corresponds to the optimal head orientation can be determined at 620 using any suitable technique. If the present and optimal head orientations correspond, then the method 600 can return to 602, where first audio information can be received. If, however, the present and optimal head orientations do not correspond at 620 following the initial prompt, then a second prompt can be initiated at 622 to the wearer 12 to turn the head 13 to the optimal head orientation.

At 624 a position of the acoustic source 300 relative to the median plane 308 of the head 13 of the wearer 12 can optionally be determined using any suitable technique.

Further, at 626, the acoustic energy based on a receiver signal utilizing the receiver 204 can optionally be outputted, where the receiver is operatively coupled to one or both of the first hearing device 16-1 and the second hearing device 16-2 using any suitable technique.

At 628, a gain of the receiver signal of the receiver 204 of either the first audio signal or the second audio signal that has the greatest signal-to-noise ratio can optionally be increased using any suitable technique. Further, at 630, a gain of the receiver signal of the receiver 204 of either the first audio signal or the second audio signal having the least signal-to-noise ratio can optionally be decreased using any suitable technique.

At 632, the image signal can optionally be determined using the camera 502 (FIG. 8) using any suitable technique, and the target acoustic source 300 can be determined based upon identification of the lip movement of the lips 301 of the target acoustic source 300 utilizing the image signal from the camera.

Embodiments of the disclosure are defined in the claims; however, herein there is provided a non-exhaustive listing of non-limiting examples. Any one or more of the features of these examples may be combined with any one or more features of another example, embodiment, or aspect described herein.

Example Ex1. An ear-wearable electronic device system that includes a first hearing device configured to be disposed on or in a first ear of a wearer and including a microphone that is configured to sense acoustic waves from an environment of the wearer and convert the sensed acoustic waves to a first audio signal, a second hearing device configured to be disposed on or in a second ear of the wearer and including a microphone that is configured to sense acoustic waves from the environment of the wearer and convert the sensed acoustic waves to a second audio signal, and a controller operatively coupled to the first and second hearing devices and including one or more processors. The controller is configured to receive first audio information based on the first audio signal and receive second audio information based on the second audio signal, determine a scene analysis based on at least one of the first audio information or the second audio information, and determine whether a present head orientation of the wearer relative to speech and one or more noise sources corresponds to an optimal head orientation based on the scene analysis. The controller is further configured to initiate a prompt to instruct the wearer to turn the head to the optimal head orientation if the present head orientation does not correspond to the optimal head orientation.

Example Ex2. The system of Ex1, where the prompt includes at least one of a visual signal, an auditory signal, or a haptic signal.

Example Ex3. The system of any one of Ex1–Ex2, where the first audio information includes a first signal to noise ratio and the second audio information includes a second signal to noise ratio. To determine the scene analysis the controller is configured to compare the first signal to noise ratio and the second signal to noise ratio.

Example Ex4. The system of Ex3, where to determine the optimal head orientation the controller is configured to determine a head orientation that increases at least one of the first signal to noise ratio or second signal to noise ratio.

Example Ex5. The system of any one of Ex1–Ex4, where the controller is further configured to determine whether the wearer turned the head from the present head orientation to the optimal head orientation following the initiated prompt.

Example Ex6. The system of Ex5, further including an inertial measurement unit (IMU) operatively connected to the controller and configured to detect motion of the head of the wearer and provide a movement signal to the controller. The controller is configured to determine whether the wearer has turned the head from the present head orientation to the optimal head orientation based on the movement signal.

Example Ex7. The system of any one of Ex5–Ex6, further including an eye sensor operatively connected to the controller. The eye sensor is configured to detect a position of at least one eye of the wearer relative to a median plane of the head and provide an eye position signal to the controller. The controller is configured to determine whether the wearer has turned the head from the present head orientation to the optimal head orientation based on the eye position signal.

Example Ex8. The system of any one of Ex5–Ex7, where the controller is further configured to initiate a second prompt to the wearer to turn the head to the optimal head orientation if the wearer has not turned the head from the present head orientation to the optimal head orientation following the initiated prompt.

Example Ex9. The system of Ex8, where the second prompt includes at least one of a visual signal, an auditory signal, or a haptic signal.

Example Ex10. The system of any one of Ex1–Ex9, where the controller is further configured to determine a position of an acoustic source relative to a median plane of the head of the wearer.

Example Ex11. The system of any one of Ex1–Ex10, further including a receiver operatively coupled to one or both of the first hearing device and the second hearing device. The receiver is configured to be in fluid communication with the first ear or the second ear, and output acoustic energy based on a receiver signal provided by the controller.

Example Ex12. The system of Ex11, where the controller is further configured to increase a gain of the receiver signal of either the first audio signal or second audio signal having the greatest signal to noise ratio.

Example Ex13. The system of any one of Ex11–Ex12, where the controller is further configured to decrease a gain of the receiver signal of either the first audio signal or second audio signal having the least signal to noise ratio.

Example Ex14. The system of any one of Ex1–Ex13, further including a camera operatively connected to the controller and configured to provide an image signal to the controller.

Example Ex15. The system of Ex14, where the controller is further configured to determine a target acoustic source based upon identification of lip movement of an audio source detected in the image signal.

Example Ex16. A method including receiving first audio information based on a first audio signal that is converted by a first microphone of a first hearing device from acoustic waves sensed by the first microphone from an environment of a wearer of the first hearing device, receiving second audio information based on a second audio signal that is converted by a second microphone of a second hearing device from acoustic waves sensed by the second microphone from the environment of the wearer, and determining a scene analysis based on at least one of the first audio information or the second audio information. The method further includes determining a present head orientation of a head of the wearer relative to speech and one or more noise sources, determining an optimal head orientation, determining whether the present head orientation corresponds to the optimal head orientation based on the scene analysis, and initiating a prompt to instruct the wearer to turn the head to the optimal head orientation if the present head orientation does not correspond to the optimal head orientation.

Example Ex17. The method of Ex16, where determining the scene analysis includes determining a first signal to noise ratio of the first audio information, determining a second signal to noise ratio of the second audio information, and comparing the first signal to noise ratio and the second signal to noise ratio.

Example Ex18. The method of Ex17, where determining the optimal head orientation includes determining a head orientation that increases at least one of the first signal to noise ratio or the second signal to noise ratio.

Example Ex19. The method of any one of Ex16–Ex18, further including determining whether the wearer turned the head from the present head orientation to the optimal head orientation after initiating the prompt.

Example Ex20. The method of Ex19, where determining whether the wearer turned the head from the present head orientation includes detecting motion of the head of the wearer, providing a movement signal based on detected motion of the head of the wearer, and determining whether the wearer has turned the head from the present head orientation to the optimal head orientation based on the movement signal.

Example Ex21. The method of Ex19, where determining whether the wearer turned the head from the present head orientation includes detecting a position of at least one eye of the wearer relative to a median plane of the head, providing an eye position signal based on the detected position of the at least one eye, and determining whether the wearer has turned the head from the present head orientation to the optimal head orientation based on the eye position signal.

Example Ex22. The method of any one of Ex19–Ex21, further including initiating a second prompt to the wearer to turn the head to the optimal head orientation if the wearer has not turned the head from the present head orientation to the optimal head orientation following the initiated prompt.

Example Ex23. The method of any one of Ex19–Ex22, further including determining a position of an acoustic source relative to a median plane of the head of the wearer.

Example Ex24. The method of Ex16, further including outputting acoustic energy based on a receiver signal utilizing a receiver that is operatively coupled to one or both of the first hearing device and the second hearing device.

Example Ex25. The method of Ex24, where determining the scene analysis includes determining a first signal to noise ratio of the first audio information, determining a second signal to noise ratio of the second audio information, and comparing the first signal to noise ratio and the second signal to noise ratio. The method further includes increasing a gain of the receiver signal of either the first audio signal or second audio signal having the greatest signal to noise ratio.

Example Ex26. The method of Ex25, further including decreasing a gain of the receiver signal of either the first audio signal or second audio signal having the least signal to noise ratio.

Example Ex27. The method of any one of Ex16–Ex26, further including determining an image signal utilizing a camera, and determining a target acoustic source based upon identification of lip movement of an audio source utilizing the image signal.

Example Ex28. The method of any one of Ex16–Ex27, where initiating a prompt includes directing at least one of a visual signal, an auditory signal, or a haptic signal to the wearer.

Example Ex29. A hearing device system that includes a first hearing device configured to be disposed on or in a first ear of a wearer, where the first hearing device includes a first microphone that is configured to sense acoustic waves from an environment of the wearer and convert the sensed acoustic waves to a first audio signal, and a first receiver configured to provide acoustic energy to the first ear based on a first receiver signal. The system further includes a second hearing device configured to be disposed on or in a second ear of the wearer, where the second hearing device includes a second microphone that is configured to sense acoustic waves from the environment of the wearer and convert the sensed acoustic waves to a second audio signal, and a second receiver configured to provide acoustic energy to the second ear based on a second receiver signal. The system further includes a controller operatively coupled to the first and second hearing devices and including one or more processors. The controller is configured to receive first audio information based on the first audio signal and receive second audio information based on the second audio signal, determine a scene analysis based on at least one of the first audio information or the second audio information, and determine whether a present head orientation of the wearer relative to speech and one or more noise sources corresponds to an optimal head orientation based on the scene analysis. The controller is further configured to initiate a prompt to instruct the wearer to turn the head to the optimal head orientation if the present head orientation does not correspond to the optimal head orientation.

Example Ex30. The system of Ex29, where the prompt includes at least one of a visual signal, an auditory signal, or a haptic signal.

Example Ex31. The system of any one of Ex29–Ex30, where the first audio information includes a first signal to noise ratio and the second audio information includes a second signal to noise ratio, where to determine the scene analysis the controller is configured to compare the first signal to noise ratio and the second signal to noise ratio.

Example Ex32. The system of Ex31, where to determine the optimal head orientation the controller is configured to determine a head orientation that increases at least one of the first signal to noise ratio or second signal to noise ratio.

Example Ex33. The system of any one of Ex29–Ex32, where the controller is further configured to determine whether the wearer turned the head from the present head orientation to the optimal head orientation following the initiated prompt.

Example Ex34. The system of Ex33, further including an inertial measurement unit (IMU) operatively connected to the controller and configured to detect motion of the head of the wearer and provide a movement signal to the controller. The controller is configured to determine whether the wearer has turned the head from the present head orientation to the optimal head orientation based on the movement signal.

Example Ex35. The system of any one of Ex33–Ex34, further including an eye sensor operatively connected to the controller, where the eye sensor is configured to detect a position of at least one eye of the wearer relative to a median plane of the head and provide an eye position signal to the controller. The controller is configured to determine whether the wearer has turned the head from the present head orientation to the optimal head orientation based on the eye position signal.

Example Ex36. The system of any one of Ex33–Ex35, where the controller is further configured to initiated a second prompt to the wearer to turn the head to the optimal head orientation if the wearer has not turned the head from the present head orientation to the optimal head orientation following the initiated prompt.

Example Ex37. The system of Ex36, where the second prompt includes at least one of a visual signal, an auditory signal, or a haptic signal.

Example Ex38. The system of any one of Ex29–Ex37, where the controller is further configured to determine a position of an acoustic source relative to a median plane of the head of the wearer.

Example Ex39. The system of any one of Ex29–Ex38, further including a camera operatively connected to the controller and configured to provide an image signal to the controller.

Example Ex40. The system of Ex39, where the controller is further configured to determine a target acoustic source based upon identification of lip movement of an audio source detected in the image signal.

Example Ex41. The system of any one of Ex29–Ex40, where the controller is further configured to determine a first signal to noise ratio of the first audio signal, and determine a second signal to noise ratio of the second audio signal.

Example Ex42. The system of Ex41, where the controller is further configured to provide the first receiver signal to the first receiver and the second receiver signal to the second receiver, and modify at least one of the first receiver signal or the second receiver signal based on a difference between the first signal to noise ratio and the second signal to noise ratio.

Example Ex43. The system of Ex42, where to modify at least one of the first receiver signal or the second receiver signal the controller is further configured to modify at least one of the first receiver signal or the second receiver signal if the difference between the first signal to noise ratio and the second signal to noise ratio is greater than a signal to noise ratio difference threshold.

Example Ex44. The system of Ex42, where to modify at least one of the first receiver signal or the second receiver signal the controller is further configured to increase a gain in at least one of the first receiver signal or the second receiver signal of either the first audio signal or second audio signal having the greatest signal to noise ratio.

Example Ex45. The system of Ex44, where to modify at least one of the first receiver signal or the second receiver signal the controller is further configured to decrease a gain in at least one of first receiver signal or the second receiver signal of either the first audio signal or second audio signal having the least signal to noise ratio.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. An ear-wearable electronic device system comprising:
a first hearing device configured to be disposed on or in a first ear of a wearer and comprising a microphone that is configured to sense acoustic waves from an environment of the wearer and convert the sensed acoustic waves to a first audio signal;
a second hearing device configured to be disposed on or in a second ear of the wearer and comprising a microphone that is configured to sense acoustic waves from the environment of the wearer and convert the sensed acoustic waves to a second audio signal; and
a controller operatively coupled to the first and second hearing devices and comprising one or more processors, the controller configured to:
receive first audio information based on the first audio signal and receive second audio information based on the second audio signal;
determine a scene analysis based on at least one of the first audio information or the second audio information;
determine whether a present head orientation of the wearer relative to speech and one or more noise sources corresponds to an optimal head orientation based on the scene analysis; and
initiate a prompt to instruct the wearer to turn the head to the optimal head orientation if the present head orientation does not correspond to the optimal head orientation.

2. The system of claim 1, wherein the first audio information comprises a first signal to noise ratio and the second audio information comprises a second signal to noise ratio, wherein to determine the scene analysis the controller is configured to compare the first signal to noise ratio and the second signal to noise ratio.

3. The system of claim 2, wherein to determine the optimal head orientation the controller is configured to determine a head orientation that increases at least one of the first signal to noise ratio or second signal to noise ratio.

4. The system of claim 1, wherein the controller is further configured to determine whether the wearer turned the head from the present head orientation to the optimal head orientation following the initiated prompt.

5. The system of claim 4, further comprising an inertial measurement unit (IMU) operatively connected to the controller and configured to detect motion of the head of the wearer and provide a movement signal to the controller, wherein the controller is configured to determine whether the wearer has turned the head from the present head orientation to the optimal head orientation based on the movement signal.

6. The system of claim 5, further comprising an eye sensor operatively connected to the controller, wherein the eye sensor is configured to detect a position of at least one eye of the wearer relative to a median plane of the head and provide an eye position signal to the controller, wherein the controller is configured to determine whether the wearer has turned the head from the present head orientation to the optimal head orientation based on the eye position signal.

7. The system of claim 1, wherein the controller is further configured to determine a position of an acoustic source relative to a median plane of the head of the wearer.

8. A method comprising:
receiving first audio information based on a first audio signal that is converted by a first microphone of a first hearing device from acoustic waves sensed by the first microphone from an environment of a wearer of the first hearing device;
receiving second audio information based on a second audio signal that is converted by a second microphone of a second hearing device from acoustic waves sensed by the second microphone from the environment of the wearer;
determining a scene analysis based on at least one of the first audio information or the second audio information;
determining a present head orientation of a head of the wearer relative to speech and one or more noise sources;
determining an optimal head orientation;
determining whether the present head orientation corresponds to the optimal head orientation based on the scene analysis; and
initiating a prompt to instruct the wearer to turn the head to the optimal head orientation if the present head orientation does not correspond to the optimal head orientation.

9. The method of claim 8, wherein determining the scene analysis comprises:
determining a first signal to noise ratio of the first audio information;
determining a second signal to noise ratio of the second audio information; and
comparing the first signal to noise ratio and the second signal to noise ratio.

10. The method of claim 9, wherein determining the optimal head orientation comprises determining a head orientation that increases at least one of the first signal to noise ratio or the second signal to noise ratio.

11. The method of claim 8, further comprising determining whether the wearer turned the head from the present head orientation to the optimal head orientation after initiating the prompt.

12. The method of claim 8, further comprising outputting acoustic energy based on a receiver signal utilizing a receiver that is operatively coupled to one or both of the first hearing device and the second hearing device.

13. The method of claim 12, wherein determining the scene analysis comprises:
determining a first signal to noise ratio of the first audio information;
determining a second signal to noise ratio of the second audio information; and
comparing the first signal to noise ratio and the second signal to noise ratio; and
wherein the method further comprises increasing a gain of the receiver signal of either the first audio signal or second audio signal having the greatest signal to noise ratio.

14. The method of claim 8, further comprising:
determining an image signal utilizing a camera; and
determining a target acoustic source based upon identification of lip movement of an audio source utilizing the image signal.

15. A hearing device system comprising:
a first hearing device configured to be disposed on or in a first ear of a wearer and comprising:
a first microphone that is configured to sense acoustic waves from an environment of the wearer and convert the sensed acoustic waves to a first audio signal; and
a first receiver configured to provide acoustic energy to the first ear based on a first receiver signal;
a second hearing device configured to be disposed on or in a second ear of the wearer and comprising:
a second microphone that is configured to sense acoustic waves from the environment of the wearer and convert the sensed acoustic waves to a second audio signal; and
a second receiver configured to provide acoustic energy to the second ear based on a second receiver signal; and
a controller operatively coupled to the first and second hearing devices and comprising one or more processors, the controller configured to:
receive first audio information based on the first audio signal and receive second audio information based on the second audio signal;
determine a scene analysis based on at least one of the first audio information or the second audio information;
determine whether a present head orientation of the wearer relative to speech and one or more noise sources corresponds to an optimal head orientation based on the scene analysis; and
initiate a prompt to instruct the wearer to turn the head to the optimal head orientation if the present head orientation does not correspond to the optimal head orientation.

16. The system of claim 15, wherein the first audio information comprises a first signal to noise ratio and the second audio information comprises a second signal to noise ratio.

17. The system of claim 16, wherein to determine the optimal head orientation the controller is configured to determine a head orientation that increases at least one of the first signal to noise ratio or second signal to noise ratio.

18. The system of claim 15, wherein the controller is further configured to determine whether the wearer turned the head from the present head orientation to the optimal head orientation following the initiated prompt.

19. The system of claim 18, further comprising an inertial measurement unit (IMU) operatively connected to the controller and configured to detect motion of the head of the wearer and provide a movement signal to the controller, wherein the controller is configured to determine whether the wearer has turned the head from the present head orientation to the optimal head orientation based on the movement signal.

20. The system of claim 18, further comprising an eye sensor operatively connected to the controller, wherein the eye sensor is configured to detect a position of at least one eye of the wearer relative to a median plane of the head and provide an eye position signal to the controller, wherein the controller is configured to determine whether the wearer has turned the head from the present head orientation to the optimal head orientation based on the eye position signal.
